(19) United States
(12) Patent Application Publication
(10) Pub. No.: US 2005/0174639 A1
(43) Pub. Date: Aug. 11, 2005

(54) Fast all-optical switches and attenuators

(76) Inventors: Zeev Zalevsky, Haayin (IL); Naim Konforti, Holon (IL); Efraim Goldenberg, Ashdod (IL); Gal Shabtay, Petach-Tikva (IL); Nadav Cohen, Tel-Aviv (IL); Uriel Levy, Tikva (IL)

Correspondence Address: William H Dippert;Reed Smith, 29th Floor, 599 Lexington Avenue, New York, NY, 10022-7650, US

(21) Appl. No.: 10/470,177

(22) PCT Filed: Jan. 22, 2002
(86) PCT No.: PCT/US02/01820

Related U.S. Application Data
(60) Provisional application No. 60/263,333, filed on Jan. 22, 2001.
(60) Provisional application No. 60/306,070, filed on Jul. 17, 2001.

(51) Int. Cl. G02B 5/30

(52) U.S. Cl. 359/484; 398/55

(57) ABSTRACT

A polarizing beam-splitter apparatus, comprising: an input port through which an input beam of lights is provided; a first polarizing beam splitter that receives the input beam and splits the beam into at least a first and second beam, said first beam having substantially a first desired polarization state and said second beam having a second polarization state orthogonal to said first polarization state but possibly admixed with the first polarization state; and an optical system that receives the second beam and provides a third beam having the second polarization state and a smaller admixture of the second polarization state than the second beam.

### RELATED APPLICATIONS

The present application claims the benefit under 119(e) of U.S. provisional application No. 60/263,333 filed 22 Jan. 2001 and U.S. provisional application No. 60/306,070 filed Jul. 17, 2001, the disclosures which are incorporated herein by reference.

### FIELD OF THE INVENTION

The present invention is related to the field of optical communication and computation networks.

### BACKGROUND OF THE INVENTION

As the size and speed limits of semiconductor technology are approached, optical networks provide an attractive alternative for communications and computation. Optical networks require switches for switching an optical signal between two or more outputs, as well as multicasters for distributing an optical signal to more than one output, and attenuators for reducing the amplitude of an optical signal. It is desirable for these elements to be all-optical, working directly with the optical signal, rather than converting it into an electronic signal and back into an optical signal.

U.S. Pat. Nos. 5,363,228, 5,414,541, and 6,041,151, the disclosures of which are incorporated herein by reference, are examples of implementations of an all-optical switch. The device described by U.S. Pat. No. 5,414,541 is a 1×2 switch, in which the light from one input channel is passed to either one of two output channels. The input channel can have any polarization state, and the output channel into which each input channel is directed has the same polarization state as the input channel. The term “polarization state” as used here includes not only any state of pure linear, elliptical or circular polarization, but also unpolarized light, and any degree of partial polarization.

The light from the input channel is passed through a polarizing beam splitter, for example a crystal of calcite, and separated into two beams of orthogonal pure polarization states, for example vertical and horizontal linear polarization. One of the beams then passes through an element which changes its polarization to be the same as the other beam. This element, for example, could be a half-wave plate of a birefringent material with its principal axis oriented at an angle of 45 degrees to the polarization of the beam, which will convert horizontally polarized light to vertically polarized light.

The two beams, now with the same polarization, are then passed through a controllable polarization rotator, which rotates the polarization by an amount that can be controlled externally. For example, a ferroelectric crystal can be used, which has a degree of birefringence that depends on the electric field that is applied to it. If no electric field is applied, then the controllable polarization rotator is inactive, and light passes through it with no change in its polarization. If an electric field of a particular direction and magnitude is applied to the ferroelectric crystal, then the controllable polarization rotator is active, and the polarization of the light changes its direction by 90 degrees when passing through it. The light is then passed through another polarizing beam splitter, which either allows the light to go straight through, or displaces it to the side, depending on the polarization of the light. If the controllable polarization rotator is inactive, then the light emerging from the second polarizing beam splitter will be directed toward the first output channel. If the controllable polarization rotator is active, then the light emerging from the second polarizing beam splitter will be displaced toward one side, and will be directed toward the second output channel.

If an electric field is applied to the controllable polarization rotator, but less than the full field needed to rotate the polarization by 90 degrees, then part of the light from the input channel will go into one output channel, and part of the light will go into the other output channel. The amount of light going into each channel is controlled by controlling the electric field in the controllable polarization rotator. The 1×2 switch is thus used as a multicaster.

U.S. Pat. No. 5,363,228 describes an all-optical cross-bar switch, using similar methods, in which each of N input channels can be directed to any of M output channels. This device suffers from various drawbacks. For example, since it uses polarization separation, 2n optical paths are required, where n is the number of input ports. In addition, complicated manufacturing and fine alignment is required.

U.S. Pat. No. 6,041,151 describes a bypass-exchange switch which operates in a similar fashion to the 1×2 switch described in U.S. Pat. No. 5,414,541. This bypass-exchange switch has two inputs and two outputs, and the two inputs are always directed to different outputs.

### SUMMARY OF INVENTION

An aspect of some embodiments of the invention concerns a polarizing beam splitter in the form of a periscope. A periscope is a structure with a place for light to enter, a place on the other side for light to exit, and two reflectors, generally parallel to each other, which the entering light reflects from, so that the light exits the periscope going in the same direction as it entered, but displaced. In the case of a polarizing beam splitter periscope, all of the light is not reflected, but some of it is transmitted through the reflectors. Light entering the periscope at the bottom strikes a transparent plate with an optical coating, for example a multi-layer optical reflective coating (which is often wavelength dependent), oriented at 45 degrees to the direction of the light, and either is reflected upward, or goes straight through and exits the periscope, depending on its polarization. The plate could be oriented at an angle other than 45 degrees, in which case the reflected portion will be deflected by an angle other than 90 degrees, and prisms and other optical elements could be used, and multiple beams could be created, but a simple coated plate at 45 degrees is best for many applications. The light reflected upward strikes another plate, optically coated as before, and generally parallel to the plate at the bottom. Although the second plate need not be parallel to the first plate, if it is parallel then the beam reflected from the second plate will be parallel to the light entering the periscope. Because this light is already polarized, most of it reflects from the second plate, and emerges from the periscope at the top, traveling parallel to the light that emerges at the bottom. A small amount of light that is polarized in the wrong direction will not reflect from the plate on the top, but will go straight through it, and will be lost. Optionally, an absorber mounted on or above the top of the periscope absorbs this light, to prevent it from being scattered and having some of it eventually getting back into the system. Hence the light emerging from the periscope at the top will have an even higher degree of polarization than the light reflected from the first plate. In an exemplary embodiment of the invention, the amount of contamination is 1%, 5%, 10%, 20% or any smaller, greater or intermediate percentage of the desired light power. The degree of reduction may be, for example, 50%, 80%, 90%, 95%, 99% or any smaller, intermediate or greater percentage.

The periscope serves the same function as a calcite crystal, splitting a beam of light into two beams of orthogonal linear polarizations. But the periscope is more compact and has a smaller footprint, since calcite only displaces light (of one polarization) by a small angle, and a long calcite crystal is needed to produce a reasonable lateral displacement of the light. On the other hand, the optically coated plates used in the periscope only work well for a limited range of wavelengths, while a calcite crystal (or a synthetic crystal with similar properties, such at yttrium vanadate) works over a broader range of wavelengths. This limitation depends on the embodiment used, and a periscope works over a broader range of wavelengths if unwanted paths are blocked, as described below. Optionally, instead of using a second optically coated a plate, a mirror is used to direct the reflected beam in the same direction as the transmitted beam. Optionally, after reflecting from the mirror, the beam passes through a polarizer to block the small amount of light that is polarized in the wrong direction. Optionally, the light that is transmitted through the optically coated plate at the entrance to the periscope also passes through a polarizer, to block the small amount of that light which is of the polarization that should be reflected. A periscope, like any polarizing beam splitter, can be used in reverse, to combine two beams of different polarizations to form a single beam.

In an exemplary embodiment of the invention, pans of beams with different initial polarizations may be converted to beams with same polarization that can travel close together so they can share optical elements.

Another aspect of some embodiments of the invention concerns an all-optical variable attenuator, or an all-optical switch which includes a variable attenuator. If the light in one of the output channels of a 1×2 switch is absorbed or otherwise discarded, then the device is a variable attenuator, modulating the intensity of the light beam at frequencies up to the maximum operating frequency of the controllable polarization rotator. To build a 1×2 switch with controllable attenuation of each output channel, one could attach two such stand-alone variable attenuators to the output channels of a 1×2 switch. However, there is an alternative embodiment in which a variable attenuator is incorporated into a 1×2 switch, such as that described in U.S. Pat. No. 5,414,541, which is simpler than adding two stand-alone variable attenuators to the output. Instead, an extra controllable polarization rotator is added in front of each output channel, before the two polarization states are recombined into a single beam by a polarizing beam splitter. If the extra controllable polarization rotator changes the direction of polarization by 90 degrees, then, when the light goes through the final polarizing beam splitter, it will be displaced to a different position than it would have been if its polarization hadn't been changed, and it will miss the output channel completely. If the extra controllable polarization rotator rotates the direction of polarization of the light by less than 90 degrees (in general it will make the light elliptically polarized in this case), then some of the light will change its polarization direction by 90 degrees, and some of it will remain in the original polarization state. Then, when the light goes through the final polarizing beam splitter, some of the light will recombine into a beam which is directed into the output channel, and some of it will be displaced by a different amount and will miss the output channel. By controlling the electric field on each of the controllable polarization rotators, the light going into each output channel can be attenuated by a controlled amount.

Another aspect of some embodiments of the invention concerns an optical switch in which unwanted paths are blocked, in order to reduce cross-talk. Cross-talk can occur between different channels if the polarizing beam splitter does not completely separate the two polarization states, or if the controllable polarization rotator, when it is supposed to be fully active, does not convert an entering light beam into a completely orthogonal polarization state, but leaves a small component of the original polarization state. Cross-talk can also result from scattering of light. Any of these conditions will generally result in a small amount of light that was intended to go into one output channel ending up in the wrong output channel. In order to reduce cross-talk, additional controllable polarization rotators are placed in front of each output channel, before the polarizing beam splitter where the two beams of pure orthogonal polarization states recombine into one beam. Each of these additional controllable polarization rotators is set so that light that is supposed to enter that output channel is allowed through with no change in its polarization, while light that is not supposed to enter that output channel (i.e. cross-talk) has its polarization state converted to the orthogonal state (rotated 90 degrees, in the case of linearly polarized light) so that it cannot enter that output channel, but is displaced off to the side when it passes through the polarizing beam splitter. Alternatively or additionally, polarizing filters, which let through light or one polarization and either absorb or scatter light of the orthogonal polarization, are placed anywhere in the optical path after the light has been directed toward one or the other output channel, and before the two beams going toward each output channel have been recombined into one beam. These polarizing filters are oriented so that they only let through light of the polarization that would be expected at that point, if all the polarizing beam splitters and controllable polarization rotators worked perfectly. Alternatively or additionally, controllable polarization rotators are placed anywhere in the optical path, even after the two beams going toward each output channel have been recombined into one beam, and polarizing filters are placed in the optical path after the controllable polarization rotators. These polarizers play the same role that the final polarizing beam splitters play, keeping light of the wrong polarization from going into the output channel. This configuration is useful if the final polarizing beam splitters are already being used for another purpose, such as variable optical attenuation (described below), so cannot also be used for blocking unwanted paths.

In some optical switching networks, unwanted paths are necessarily blocked, in order to make it possible to connect all the desired input channels to each output channel. This is true, for example, in the selector part of the router-selector optical switching network shown in FIG. 7. There is a controllable polarization rotator at the exit of each periscope (which functions as a beam combiner rather than a beam splitter) in the selector section of the network, where light from all the input channels going into a given output channel is repeatedly combined in a binary tree. The controllable polarization rotator must be active, rotating the polarization of light going through it by 90 degrees, whenever the light from the left side of one periscope enters the right side of the periscope above it, or vice versa, in the schematic view in FIG. 7, and this automatically blocks the unwanted light from the other side of that lower periscope from entering that upper periscope. In other optical switching networks, blocking of unwanted paths is not a necessary part of the network, but is an optional added feature which improves performance by reducing cross-talk. That is true, for example, in the 2×2 switch shown in FIG. 6.

Blocking unwanted paths increases the range of wavelengths that periscopes operate at, and decreases the tolerances for manufacture of periscopes. Thus two of the significant disadvantages of using periscopes as polarizing beam splitters are at least partially overcome, and it becomes possible to take advantage of the desirable features of periscopes, such as their small size.

Another aspect of some embodiments of the invention concerns optical switches in which the parts of the switch are arranged in a three-dimensional configuration which is compact easy to manufacture, or otherwise advantageous. One way to accomplish this is to use half-wave plates, with principle axes oriented at an oblique angle, before and after one or more of the controllable polarization rotators. This makes it possible to change the orientation of the principle axes of the controllable polarization rotator, in order to make the controllable polarization rotator fit better into the layout of the switch. In particular, if the controllable polarization rotator is a ferroelectric crystal, or a ceramic using the Kerr effect, then an electric field needs to be applied to it along one of the principle transverse axes, and a large uniform electric field is most readily applied if the controllable polarization rotator is short in that dimension, and has large, flat electrodes attached to its sides. (Similarly, if the controllable polarization rotator uses the Faraday effect, then a large uniform magnetic field is most readily applied if the controllable polarization rotator is short in the direction of the field.) If the polarizing beam splitter displaces the beam in a direction parallel to the direction of polarization of the displaced beam, then it is often most convenient to use a layout for the switch whose envelope has a rectangular cross-section, with principle axes parallel and perpendicular to the direction of polarization of the displaced beam. But the electric field in the controllable polarization rotator, in the case of a ferroelectric crystal or electro-optic ceramic, is at a 45 degree angle to the direction of polarization of the light that passes through it. By placing half-wave plates, oriented with their principle axis 22.5 degrees to the direction of beam displacement, before and after the controllable polarization rotator, the principle axes of the controllable polarization rotator can be aligned with the principle axes of the rectangular cross-section of the envelope of the switch, and in particular the short dimension of the controllable polarization rotator can be aligned with the short dimension of the envelope.

Another aspect of some embodiments of the invention concerns an optical switch or another optical configuration in which parts are mounted on rotatable bearings, such as ball and socket bearings. The parts are aligned, for example by hand or machine, and when alignment is achieved, ultraviolet light is applied to a UV cured adhesive in the bearing, curing the adhesive and fixing the bearing in place. The adhesive can be applied to the bearing before or after the parts are aligned. Optionally, if the adhesive is applied before the parts are aligned, it is viscous enough so that the alignment will not slip spontaneously before the adhesive is cured, but is not so viscous that it is difficult to perform the alignment.

Another aspect of some embodiments of the invention concerns all-optical router-selector networks. Such a network is built up of polarized beam splitters (which can be, for example, periscopes, as described above, or calcites), and controllable polarization rotators. The aspects of the invention described previously, especially the techniques used to make a compact three-dimensional layout, are especially useful in a network with a large number of inputs and outputs. As used herein, “calcite” means any material with similar birefringent properties, including synthetic materials such as yttrium vanadate (YVO₄).

Another aspect of some embodiments of the invention concerns all-optical switches with controllable polarization rotators using lead lanthanum zirconate titanate (PLZT), an electro-optic ceramic (using the Kerr effect) which has a response time of only 10 to 100 nanoseconds, much faster than the response time of ferroelectrics and nematic liquid crystals. However, the change in index of refraction in PLZT is proportional to the square of the electric field, in contrast to ferroelectrics where it is linear, and the effect is rather weak. Since operating at high voltage causes increased scattering of light, PLZT is often used at moderate voltages (20 to 80 volts), in which case a longer interaction length is needed (compared to ferroelectrics) to rotate the polarization by 90 degrees.

Another aspect of the invention concerns the ability to scale up a 1×2 or 2×2 optical switch to have many parallel input channels, each connected to its own one or two output channels. This can be done when the layout of the single 1×2 or 2×2 switch is essentially two-dimensional, for example the 1×2 switch design shown in FIG. 2 or the 2×2 switch shown in FIG. 6. Calcites, periscopes, and half-wave plates can simply be extended in a direction perpendicular to the plane of the drawing. Even controllable polarization rotators can be extended in this way if their electric field is in the plane of the paper, i.e. vertical in the case of a ferroelectric or an electro-optic ceramic, and horizontal (in the direction of propagation of the light) in the case of a twisted nematic liquid crystal. Then an arbitrary number of input and output channels can be lined up side by side.

There is thus provided in accordance with an exemplary embodiment of the invention, a polarizing beam-splitter apparatus, comprising:
an input port through which an input beam of light is provided;
a first polarizing beam splitter that receives the input beam and splits the beam into at least a first and second beam, said first beam having substantially a first desired polarization state and said second beam having a second polarization state orthogonal to said first polarization state but possibly admixed with the first polarization state; and
an optical system that receives the second beam and provides a third beam having the second polarization state and a smaller admixture of the second polarization state than the second beam. Optionally, the first beam splitter comprises a first planar surface that reflects light having the second polarization state and transmits light having the first polarization state and wherein the input beam is incident on the surface at a first angle. Optionally, the first angle is substantially 45°.

In an exemplary embodiment of the invention, the optical system comprises a polarizing beam splitter that receives the second beam and splits the second beam into the third beam and a fourth beam having substantially the first polarization state. Alternatively or additionally, the optical system comprises a second beam splitter having a second planar surface that reflects light having the second polarization state and transmits light having the first polarization state and wherein the second beam is incident on the second planar surface at a second angle and light reflected by the second surface from the second beam forms the third beam and light transmitted by the second surface forms a fourth beam. Optionally, the apparatus comprises an absorber that receives the fourth beam. Alternatively or additionally, the second angle is substantially 45°. Alternatively or additionally, the first and second surfaces are substantially parallel as a result of which, the first and third beams are parallel and displaced from each other. Alternatively or additionally, the first and second surfaces are surfaces formed on a same substrate material substantially transparent to light in the input beam.

In an exemplary embodiment of the invention, the apparatus comprises:
at least one controllable polarization rotator positioned to receive one of the first and third beams and operable to change the polarization state of the beam it receives; and
a polarizer that receives the beam from the rotator and transmits an amount of optical energy in the received beam responsive to the polarization state of the beam. Optionally, the at least one controllable polarization rotator comprises a polarization rotator for each of the first and second beams. Alternatively or additionally, the polarization rotator comprises:
at least one volume of PLZT through which light received by the rotator is transmitted; and
at least one electrode for applying a voltage to the volume of PLZT, which voltage controls the state to which the rotator changes the polarization of light that the rotator receives.

In an exemplary embodiment of the invention, the apparatus comprises a pair of polarization rotators arranged around said polarization controller, to rotate polarization of light entering and exiting said controller. Optionally, an electric field direction of said controller is perpendicular to a plane common to said beams.

There is also provided in accordance with an exemplary embodiment of the invention, a n optical switch comprising an input port through which the switch receives light and first and second output ports to which the switch selectively directs light that it receives comprising:
a first polarization state apparatus that receives light from the input port and provides a light beam having a desired polarization state;
a polarizing beam-splitter apparatus as described above that receives the light beam from the polarization state apparatus at the beam splitter apparatus input port and generates at least one first beam and/or at least one third beam responsive to the polarization of the light that it receives; and
wherein the first output port receives light from the at least one first beam and the second output port receives light from the at least one third beam. Optionally, the switch comprises:
a polarizing beam splitter that receives light from the input port and generates fifth and sixth spatially separated beams therefrom said fifth beam having substantially a third polarization state and said sixth beam haying a fourth polarization state substantially orthogonal to the third state;
a second polarization state apparatus that receives the first and second beams of light and changes the polarization state of at least one of the fifth and sixth beams so that the polarization state of both beams is the same; and
   wherein the fifth and sixth beams are directed to the input port of the beam splitter apparatus, which apparatus generates a first and/or third beam responsive to the fifth beam and a first and/or third beam responsive to the sixth beam. Optionally, the switch comprises a first polarizer through which light from the first beams from the polarizing beam-splitter apparatus is transmitted and wherein said first polarizer transmits substantially only light having the first polarization state. Alternatively or additionally, the switch comprises a second polarizer through which light from the third beams from the polarizing beam-splitter apparatus is transmitted and wherein said second polarizer transmits substantially only light having the second polarization state. Alternatively or additionally, the switch comprises:
an first optical combiner that combines light in the first beams provided by the beam splitter apparatus responsive to light in the fifth and sixth beams and directs the combined light to the first output port. Optionally, the switch comprises:
a second optical combiner that combines light in the third beams provided by the beam splitter apparatus responsive to light in the fifth and sixth beams and directs the combined light to the second output port.

In an exemplary embodiment of the invention, the first optical combiner comprises:
a third polarization state apparatus that receives the first beam provided from light in the fifth beam and transmits the light in the third polarization state and receives the light in the first beam provided by light from the sixth beam and transmits the light in the fourth polarization state;
an optical joiner that receives light in first beams from the third polarization state apparatus and combines the received light into a single beam that is transmitted to the first output port.

Alternatively or additionally, the second optical combiner comprises:
a fourth polarization state apparatus that receives the third beam provided from light in the fifth beam and transmits the light in the third polarization state and receives the light in the third beam provided by light from the sixth beam and transmits the light in the fourth polarization state;
an optical joiner that receives light in the third beams from the fourth polarization state apparatus and combines the received light into a single beam that is transmitted to the second output port.

In an exemplary embodiment of the invention, the switch comprises a first controllable attenuator controllable to attenuate light from the first combiner by a desired attenuation before the light reaches the first output port. Alternatively or additionally, the switch comprises a second controllable attenuator controllable to attenuate light from the second combiner by a desired attenuation before the light reaches the second output port.

In an exemplary embodiment of the invention, the first attenuator comprises:
at least one controllable polarization rotator positioned to receive the light from the first combiner and operable to change the polarization state of the light it receives; and
a polarizer that receives the beam from the rotator and transmits an amount of optical energy in the received responsive to the polarization state of the light.

In an exemplary embodiment of the invention, the second attenuator comprises:
at least one controllable polarization rotator positioned to receive the light from the second combiner and operable to change the polarization state of the light it receives; and
a polarizer that receives the beam from the rotator and transmits an amount of optical energy in the received responsive to the polarization state of the light.

In an exemplary embodiment of the invention, the polarization rotator comprises:
at least one volume of PLZT through which light received by the rotator is transmitted; and
at least one electrode for applying a voltage to the volume of PLZT, which voltage controls the state to which the rotator changes the polarization of light that the rotator receives.

There is also provided in accordance with an exemplary embodiment of the invention, a switch array comprising a plurality of switches as described herein, sharing an elongated optical element, said elongation being perpendicular to a plane of each of said switches.

In an exemplary embodiment of the invention, the switch comprises at least one reflector for folding an optical path of said switch.

There is also provided in accordance with an exemplary embodiment of the invention, a compound optical switch comprising at least two optical switches as described herein where the first output port of each optical switch is a same single first shared output port and the second output port of each optical switch is a same single second shared output port.

There is also provided in accordance with an exemplary embodiment of the invention, a compound optical switch comprising a cascade of optical switches wherein an n-th tier of the cascade comprises 2ⁿ optical switches as described herein and where light from the first and second output ports of an optical switch in the n-th tier is input to the input ports of two optical switches in the (n+1)-st tier. Optionally, each optical switch in the n-th tier receives light from only a single output port of the optical switches in the (n−1)st tier. Alternatively or additionally, the switch comprises N tiers and comprising an output port that receives light from at least two output ports of the optical switches in the n-th tier.

There is also provided in accordance with an exemplary embodiment of the invention, a router-selector optical switching network, comprising:
a number of input channels equal to a power of two;
a number of output channels equal to the same or a different power of two;
a router section for each input channel comprising a binary branching tree of polarizing beam splitters, light paths joining them, and controllable polarization rotators;
a selector section for each output channel comprising a binary branching tree of polarizing beam joiners, light paths joining them, and controllable polarization rotators;
wherein the controllable polarization rotators operate to control the connection of any output channel to at most one input channel and any input channel to at most one output channel. Optionally, the light paths of each router are co-planar, the light paths of each selector are co-planar, the planes of all the router light paths are parallel to each other, the planes of all the selector light paths are parallel to each other, and the planes of all the router light paths are perpendicular to the planes of all the selector light paths. Alternatively or additionally, at least one of the polarizing beam splitters or one of the polarizing beam joiners is a polarizing beam splitter apparatus as described herein.

There is also provided in accordance with an exemplary embodiment of the invention, a method of aligning a first optical element with a second optical element comprising:
mounting the first optical element on a first part of a support comprising first and second parts, wherein the first part is movably coupled to the second part;
mounting the second part of the support in a fixed position relative to the second optical element;
applying a curable adhesive to the support so that the adhesive contacts both the first and second parts;
moving the first part so that the first optical element is aligned with the second optical element; and
curing the adhesive to secure the first part in the aligned position.

There is also provided in accordance with an exemplary embodiment of the invention, comprising:
a substrate;
at least two optical elements that lie in a same path and are coupled to said substrate; and
at least one ball and socket joint formed between at least one of said elements and said substrate, such that said one element can be oriented on said joint in a plurality of orientations relative to the other one of said elements. Optionally, the configuration comprises curable adhesive in the bearing. Optionally, the curable adhesive is cured by ultraviolet light.

In an exemplary embodiment of the invention, said adhesive is viscous and prevent slipping of said joint when no external forces are applied to said optical element. Alternatively or additionally, said one optical is transparent to ultraviolet light.

In an exemplary embodiment of the invention, said ball is on said substrate. Alternatively, said ball is on said element.

In an exemplary embodiment of the invention, said ball is integral to one of said substrate and said element. Alternatively, said ball is mounted on one of said substrate and said element. Optionally, said ball is attached using an adhesive to said one of said substrate and said element.

### BRIEF DESCRIPTION OF THE DRAWINGS

Exemplary embodiments of the invention are described in the following section with reference to the drawings. The drawings are generally not to scale.

FIG. 1 is a schematic side view of a periscope, according to an exemplary embodiment of the invention;

FIG. 2 is a schematic side view of a 1×2 switch, according to an exemplary embodiment of the invention. FIG. 2A is a side view of the details of one end of the same switch near the output channels;

FIG. 3A is a schematic side view, and FIG. 3B is a schematic top view, of a 1×2 switch, according to another exemplary embodiment of the invention. FIG. 3C and FIG. 3D are schematic cross-sectional views of a 1×2 switch according to the same embodiment of the invention as shown in FIG. 3A and FIG. 3B, at different axial locations;

FIG. 3E is a schematic view of a 1×2 switch according to another exemplary embodiment of the invention;

FIG. 4 is a three-dimensional perspective view of a 2×2 switch, showing only the optical elements but not the mountings, according to an exemplary embodiment of the invention;

FIG. 5A is a schematic three-dimensional perspective view of a 2×2 switch, according to another exemplary embodiment of the invention. FIG. 5B is a schematic side view, and FIG. 5C is a schematic top view, of a 2×2 switch according to the same embodiment of the invention as FIG. 5A. FIG. 5D and FIG. 5E are schematic cross-sectional views of a 2×2 switch at different axial locations, according to the same embodiment of the invention as FIG. 5A;

FIG. 6 is a schematic side view of a 2×2 switch, according to another exemplary embodiment of the invention;

FIG. 7 is a schematic diagram of part of an optical implementation of a router-selector network with four input channels and four output channels, showing the topology of the network;

FIG. 8 is a schematic top view of the layout of the router part of a 4×4 optical router-selector network; and

FIG. 9 schematically shows the entrance stage of a router-selector network using unpolarized light

### DETAILED DESCRIPTION OF THE INVENTION

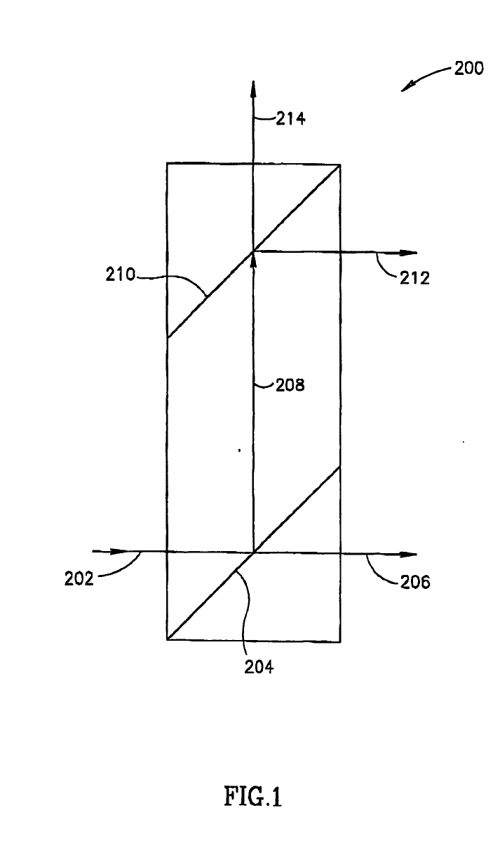

FIG. 1 shows a periscope shaped component 200, according to an exemplary embodiment of the invention, which is used in some all-optical switches as a polarizing beam splitter. A polarizing beam splitter splits a beam into two linearly polarized beams with orthogonal directions of polarization, for example horizontal and vertical, with the two beams traveling in the same direction with one-beam displaced to the side, relative to the other beam. A light beam 202 enters periscope 200 at the lower left, and impinges on plate 204, which is mounted in the periscope at angle of 45 degrees to the direction of beam 202. The terms horizontal and vertical are used for clarity, the actual polarization directions are not generally required to be at any particular orientation relative to the perpendicular.

Plate 204 is coated with one or more optical coatings, whose thickness and index of refraction is such that they transmit one polarization and reflect the orthogonal polarization of light of the same wavelength as beam 202 which strikes it at a 45 degree angle. Light which is linearly polarized in a horizontal direction substantially passes through the plate without deflection, and emerges as a horizontally polarized beam 206, polarized in a direction perpendicular to the plane of the drawing. The part of the light in beam 202 which is polarized vertically is substantially all reflected, and travels upward as beam 208, with its polarization now in a left-right direction. It should be noted that a “reflective plate” may be implemented in various manners, for example by coating a surface of a glass element. For example, in many of the figures, the periscope is formed of a solid matrix, for example, bonded together plates, prisms and other optical elements. However, this is not essential and an open construction, with suitable spacers and scaffolding between the optical elements may be used instead.

Beam 208 then strikes plate 210, which is mounted parallel to plate 204, and is coated with the same kind of coating as plate 204, or another kind of coating which has the same property of reflecting or transmitting light according to its polarization, when light of the wavelength of beam 202 strikes it at a 45 degree angle. Because beam 208 is already largely linearly polarized in the left-right direction, most of it reflects from plate 210, and emerges from the periscope as a beam 212, which is linearly polarization the vertical direction. To the extent that a small amount of beam 208 is polarized in a direction perpendicular to the plane of the drawing, most of that component will emerge from the periscope vertically as a beam 214, which can be absorbed or otherwise discarded. As a result, beam 212 is even more in a pure state of linear polarization, in the plane of the drawing, than beam 208 is.

Optionally, beam 206 is made to pass through another coated plate (not shown in FIG. 1), oriented at the same angle as plate 204, or oriented perpendicular both to plate 204 and the plane of the drawing, so that any small component of vertically polarized light is deflected up or down, and beam 206 emerges with an even purer degree of horizontal linear polarization. Alternatively or additionally, beam 206 is made to pass through a polarizing plate which substantially removes vertically polarized light and passes horizontally polarized light.

A potential advantage of using a periscope as a polarizing beam splitter is that it is shorter in the direction of travel of the light, for the same beam displacement, than an alternative polarizing splitter, such as a crystal of calcite, or of another bifringent material such as yttrium vanadate. Potential disadvantages of the periscope include the need to accurately align the plates in three dimensions, and to accurately prepare the optical coatings, and the fact that the coatings are often designed to work only for a relatively narrow range of wavelengths, typically 100 angstroms or less, while calcite and similar materials typically have a wider wavelength operating range. Although ideally the plates do not absorb any light or scatter in it in other directions, in practical designs some of the light is absorbed or scattered, and the combined power of beams 206 and 212 is less than the power of beam 202. If a polarizer is put in the path of beams 206 and 212, oriented so as to transmit only the polarization that the beams are ideally supposed to have, then the periscope works over a wider range of wavelengths, and does not have to be manufactured to as tight tolerances.

The actual angle at which plates 210 and 204 are mounted, nominally 45 degrees to the direction of propagation of beam 202, is not as important as the requirement that the plates be nearly parallel to each other. If the plates are mounted at a different angle than 45 degrees, but still parallel to each other, then beam 208 will not be vertical, but will travel at an angle to the vertical. But this will not affect the operation of the periscope as long as beam 208 hits plate 210 and beam 212 exits from the periscope along the proper path. If plate 204 is not parallel to plate 210, then beam 212 will not emerge parallel to beams 206 and 202, and the operation of the device may be more seriously affected. In particular, it will not be possible to align the paths of both beams if the rest of the switch is designed assuming that the paths of the beams are parallel, and even if the design takes the possibility of non-parallel beams into account, it will take more effort to align all the optics.

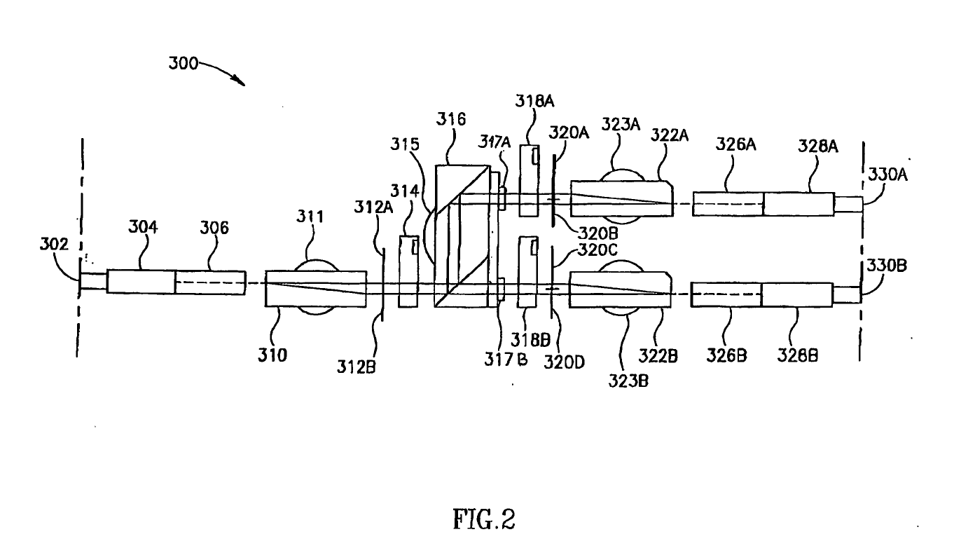

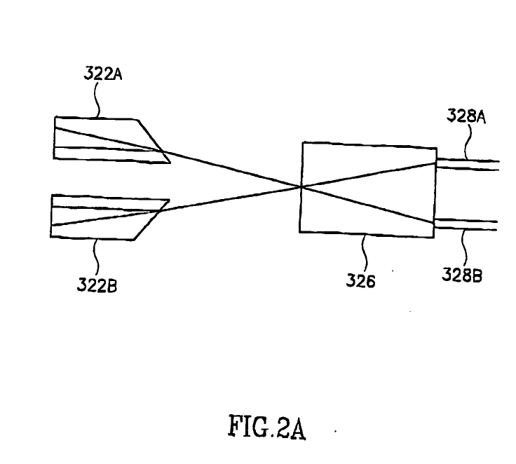

FIG. 2 shows a 1×2 all-optical switch 300, according to an embodiment of the invention. In switch 300, there is an input beam of light 302, which is conveyed to either of two output channels 330A or 330B. Input beam 302, which is, for example, traveling along a fiber optic cable, is collimated to enter a calcite crystal 310. Collimation is accomplished by a ferrule 304 and a gradient-index lens 306, or by any other means known to the art. Optionally, another type of bifringent crystal, for example a synthetic crystal such as yttrium vanadate, is used instead of calcite. Optionally, any other type of polarizing beam splitter is used instead of calcite, including a periscope such as that shown in FIG. 1. Optionally, calcite 310 is mounted on a bearing 311, for example a ball and socket bearing, which allows it three degrees of rotational freedom, in order to align it with the input beam 302 which is entering it, and in order to align the beams exiting it with the optical elements to the right of it in FIG. 2. Optionally, bearing 311 also has one or more translational degrees of freedom, for example, including steps, or being elongated or otherwise distorted in a certain direction. In an exemplary embodiment of the invention, the socket is an elongate socket in a direction of translational freedom. Optionally, bearing 311 has only one or two rotational degrees of freedom. Calcite 310 is rotated and/or translated on bearing 311, with beam 302 turned on, until it is aligned correctly. The correct alignment is determined, for example, by observing the two beams exiting calcite 310, and seeing that they impinge at the proper place on the next element, or any other means of alignment is used. Once calcite 310 is correctly aligned, bearing 311 is optionally fixed in place. For example, bearing 311 contains an uncured UV cured adhesive, and once calcite 310 is aligned, ultraviolet light is used to cure the adhesive.

Calcite 310 is oriented so that the two beams emerging from it are polarized at angles of 45 degrees in opposite directions from the vertical. The upper beam passes through half-wave plate 312A, and the lower beam passes through half-wave plate 312B. Half-wave plates 312A and 312B are made of a birefringent material, in which the index of refraction for light polarized along one principal axis is different from the index of refraction of light polarized along the other principal axis. The thickness of plates 312A and 312B is such that, for light of the wavelength in beam 302, light polarized along one principle axis will have half a wavelength more across the thickness of the plate than light polarized along the other principal axis. Plate 312A has a principle axis oriented at 22.5 degrees on one side of the vertical, and plate 312B has a principle axis oriented at 22.5 degrees on the other side of the vertical. The beam passing through plate 312A is polarized 45 degrees from the vertical, on the same side of the vertical as the principal axis of plate 312A, while the beam passing through plate 312B is polarized 45 degrees from the vertical, on the same side of the vertical as the principle axis of plate 312B. Thus, both beams emerge from their plates with vertical polarization.

The two vertically polarized beams emerging from plates 312A and 312B enter a controllable polarization rotator 314. The controllable polarization rotator is optionally made of a ceramic electro-optic material, such as lead lanthanum zirconate titanate (PLZT, for example PbₓLa₍₁₋ₓ₎(Zr_{y}Ti_{z})(1−x/4) (x=9 or 8.5, y=65, z=35)), which has index of refraction that differs for light polarized in the direction of an applied electric field, and light polarized transverse to that direction. If an electric field is applied at an angle of 45 degrees to the vertical, of magnitude such that the difference in the two indexes of refraction will lead to a difference in half a wavelength (or any odd number of half wavelengths) for light propagating across the length of the PLZT, then light that is initially polarized vertically will emerge with its polarization horizontal, and vice versa. If no electric field is applied to the PZLT, then the light will emerge with the same polarization as it started with.

Alternatively, a material which exhibits an magneto-optic effect (e.g., Faraday rotation) can be used instead of the PLZT. Here the beam is parallel to magnetic field lines. In order to reduce the cross talk resulted from non-accurate rotation of the polarization the temperature of the faraday rotator is optionally kept at the optimal temperature of the rotator which is used.

Alternatively, other materials which respond according to the Kerr or the Pockels effect can be used. Also, a ferroelectric crystal such as lithium niobate, or a ferroelectric liquid crystal, can be used for the controllable polarization rotator. Such materials work similarly to electro-optic ceramics, but have slower response time, and do not require as high an electric field. Alternatively, nematic liquid crystals, twisted or untwisted, can be used. In the case of twisted nematic liquid crystals, the electric field is applied along the direction of propagation of the light, and makes the material not affect polarization. When no electric field is applied, a linearly polarized beam of light has its direction of polarization rotate as it propagates through the material. Such liquid crystals have even slower response time than ferroelectrics.

When the two beams of light enter controllable polarization rotator 314 with vertical polarization, if rotator 314 is inactive (e.g., does not provide rotation, even if, for some materials, an electric field is present), the beams emerge with polarization vertical, and when they enter a periscope 316, they are reflected off the two plates in the periscope and exit the periscope at the top. If controllable polarization rotator 314 is active, then the two beams of light emerge with horizontal polarization (in a direction perpendicular to the plane of the drawing), and they go straight through periscope 316, emerging at the bottom of periscope 316. In the first case, the beams will end up at an output channel 330A, at the upper right of FIG. 2, while in the second case, the beams will end up at an output channel 330B, at the lower right of FIG. 2. The state of polarization rotator 314, whether it is active or inactive, thus determines which output channel the light will end up at.

There are other ways of configuring calcite 310, half-wave plates 312A and 312B, and controllable polarization rotator 314, which will result in the beams entering periscope 316 selectively having either horizontal or vertical polarization. For example, calcite 310 is oriented so that the two beams emerging from it are polarized vertically and horizontally, and the horizontally polarized beam passes through a half-wave plate, say 312A, which is oriented with its principle axes at a 45 degree angle to the vertical, while the vertically polarized beam goes straight to controllable polarization rotator 314, without passing through a half-wave plate at all. Then both beams are vertically polarized when they reach controllable polarization rotator 314. Alternatively, only the vertically polarized beam passes through a half-wave plate, and both beams arrive at controllable polarization rotator 314 with horizontal polarization. Optionally, controllable polarization rotator 314 is oriented with its principle axis at an angle other than 45 degrees, and an additional half-wave plate, between controllable polarization rotator 314 and periscope 316, rotates the direction of polarization of light emerging from controllable polarization rotator 314 so that it is polarized vertically or horizontally when it enters periscope 316. There are many other configurations which will be obvious to someone skilled in the art.

Optionally, periscope 316 is replaced by a calcite, oriented in such a way as to separate light polarized vertically from light polarized horizontally. However, a calcite will have to be much longer than periscope 316 to obtain the same spatial separation between light going into different output channels.

Optionally, light emerging from periscope 316 passes through a polarizer 317A if it emerges at the top, and/or a polarizer 317B if it emerges at the bottom. These polarizers either absorb or scatter most light of the wrong polarization, and pass most of the light of the polarization that is supposed to emerge from that part of periscope 316, viz vertical polarization at the bottom, and horizontal polarization at the top. The polarizers thus reduce cross-talk, the phenomenon of some light entering the wrong output channel because, for example, controllable polarization rotator 314 does not accurately rotate the polarization of light traversing it and/or periscope 316 does not perfectly separate light of vertical polarization from light of horizontal polarization. Optionally, there is only one polarizer, 317B, in front of the bottom of periscope 316, because light emerging from the top of periscope 316 has already been reflected from two polarizing plates inside periscope 316, and is more purely polarized in the right direction than light emerging from the bottom of periscope 316, which has only passed through one polarizing plate.

Each of the two beams then passes through one of the four half-wave plates 320A, 320B, 320C, or 320D, which restores its original polarization direction. If the beams emerge from the top of periscope 316, then they pass respectively through half-wave plates 320A and 320B. The orientation of plates 320 is related to the orientation of half-wave plates 312A and 312B. For example, if the beams emerge from half-wave plates 312A and 312B with vertical polarization, as they do in the original configuration described above, then, if controllable polarization rotator 314 is inactive, the beams will exit periscope 316 at the top also with vertical polarization. Half-wave plates 320A and 320B then have the same orientation of their principle axes as half-wave plates 312A and 312B, and the beams emerge from half-wave plates 320A and 3120B with the same directions of polarization as they had when they left calcite 310.

The beams then enter a calcite 322A, which is oriented in such a way as to recombine the two beams into a single beam, with the same polarization state (including possibly an unpolarized state) as the light which entered calcite 310. If controllable polarization rotator 314 is active, then the beams will emerge from the lower part of periscope 316, instead of from the upper part, and they will have horizontal polarization instead of vertical polarization. In order to restore the polarization of the beams to the original polarization that they had when emerging from calcite 310, half-wave plates 312C and 312D have principle axes oriented 22.5 degrees and 67.5 degrees from the vertical. The beams then enter calcite 322B, which is oriented in such a way as to recombine the two beams into a single beam, with the same polarization state as the beam which entered calcite 310.

Optionally, in order to further reduce cross-talk, there are two controllable polarization rotators 318A and 318B together with, respectively, caclites 322A and 322B, one for light emerging from the top part of periscope 316 and one for light emerging from the bottom part of periscope 316. If the light is being directed into output channel 330A, then most of the light emerges from the upper part of periscope 316, but due to imperfections in the performance and orientation of the optical elements, some light emerges from the bottom part of periscope 316. To keep this light out of output channel 330B, particularly if polarizers 317A and 317B are not used, controllable polarization rotator 318B is active, rotating the polarization direction by 90 degrees. When this light enters calcite 322B, it will not have the proper polarization to be recombined into a single beam that is aligned to enter output channel 330B, but will instead be displaced to the side, where optionally it is absorbed, to prevent some of it from eventually entering output channel 330B after further scattering. Controllable polarization rotator 318A, on the other hand, is inactive, so the light entering calcite 322A is polarized in the proper direction to recombine into a single beam, and enter output channel 330A.

Many other configurations are possible, and will occur to persons of the art which accomplish the same result, with minor structural variations, using the same inventive concept. For example, controllable polarization rotator 318B is active when the light is supposed to go into output channel 330B, and inactive when the light is supposed to go into output channel 330A, and half-wave plates 320C and 320D have the same orientation of their principle axes as half-wave plates 312A and 312B. Then, when the light is supposed to go into output channel 330B, controllable polarization rotator 318B changes the polarization of the light emerging from the lower part of periscope 316 from horizontal to vertical, and half-wave plates 320C and 320D restore the polarization of the beams entering calcite 322B to the same polarization as the beams had when they emerged from calcite 310, so that calcite 322B can recombine them into a single beam. Many other possible configurations will be obvious to someone skilled in the art.

Calcites 322A and 322B are optionally mounted on bearings 323A and 323B, which are used to align them, as described above for calcite 310. Light emerging from calcite 322A enters a gradient-index lens 326A which focuses it on a fiber optic cable (optionally held by a ferrule 328A) which constitutes output channel 330A. A similar gradient-index lens 326B and ferrule 328B are used to bring light emerging from calcite 322B into output channel 330B.

If an electric field is applied to controllable polarization rotator 314 which is less than the electric field needed to make it rotate the polarization by 90 degrees, then vertically polarized light entering it will emerge with an elliptical polarization that is a combination of vertical and horizontal polarization. As a result, some of the light will end up in output channel 330A and some of it will end up in output channel 330B, with the relative amount of light in the two channels depending on the electric field applied to controllable polarization rotator 314. In this mode, the switch operates as a multicaster, distributing an input signal to two (or more) output channels. In this mode of operation, neither controllable polarization rotator 318A or 318B is active, since some light is supposed to end up in both channels. If one of the output channels is terminated by a material which absorbs light, or the light is otherwise discarded, then the multicaster becomes a variable attenuator, in which the amplitude of light in the one remaining output channel is reduced from its value in the input channel, by an amount that depends on the electric field applied to controllable polarization rotator 314. Variable attenuation in the output can also be achieved, even when the switch or multicaster is operating with two output channels, by changing the electric field in controllable polarization rotators 318A and 318B. If these are operated at an electric field less than that needed to make them rotate the polarization direction by 90 degrees, then the light going into the corresponding output channel 330A or 330B will be reduced in power from what it would be if controllable polarization rotators 318A and 318B were not operating at all, but the light will not be eliminated from that channel completely. The switch may also be hardwired (e.g., by omitting or replacing elements) and/or permanently electrically controlled to be a variable attenuator and/or multicaster.

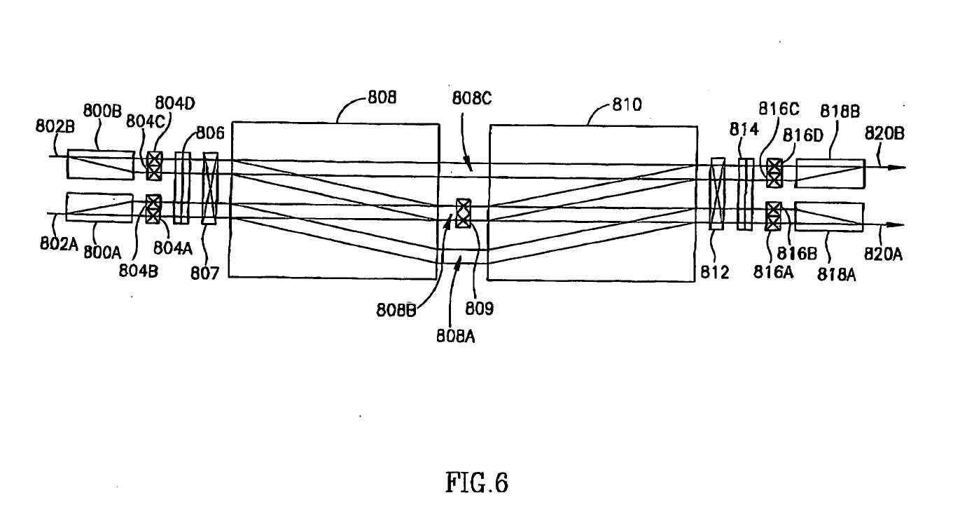

In an exemplary embodiment of the invention, the switch (e.g., FIGS. 2 and 6) can be scaled, for example by arranging an array of N 1×2 switches side by side. In an exemplary embodiment of the invention, this is done by elongated some of the optical elements (e.g., calcite 310, periscope 316 and calcites 322) in a direction perpendicular to the page, with the multiple input and output channels optionally being arranged in the same direction. Alternatively, for example in order to facilitate the alignment either the YVO₄ 200 or YVO₄ 220 or YVO₄ 204 can be replaced by a set of N smaller YVO₄ similar to 310 of FIG. 2. In an exemplary embodiment of the invention, the switch manufactured by assembly. Alternatively lithography or other on-substrate forming methods are used. The final switch may be discretely packaged component or may be part of a network or an array of switches, for example as described elsewhere in this application. Both small- and large-sized optical switches may be manufactured, for example in the in, cm, mm or sub mm size ranges.

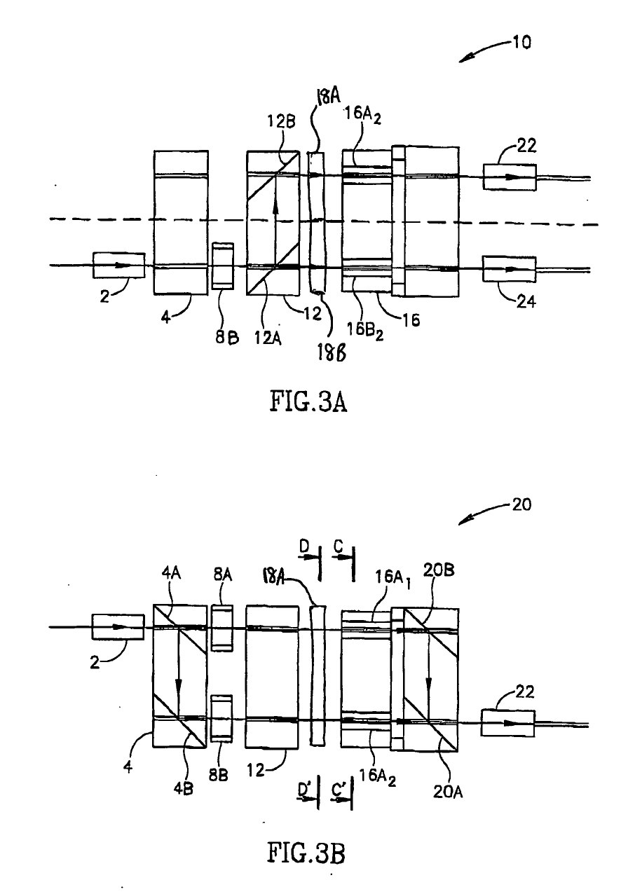

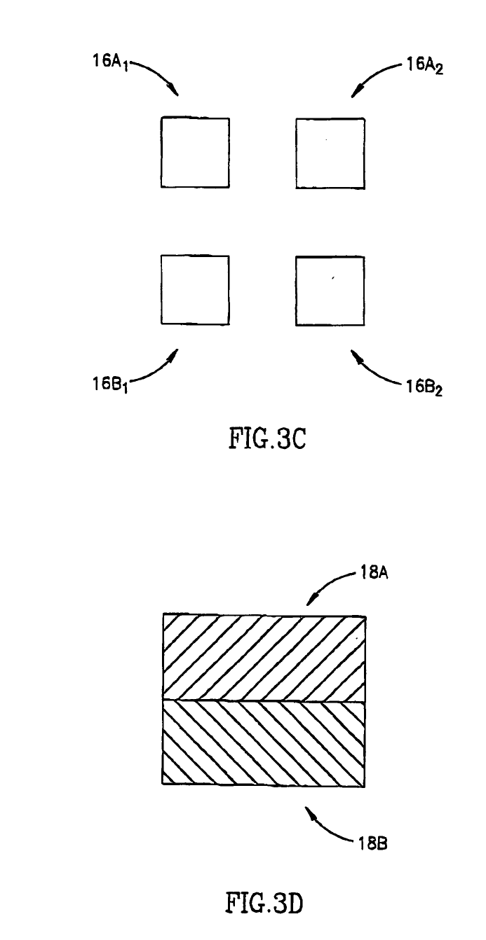

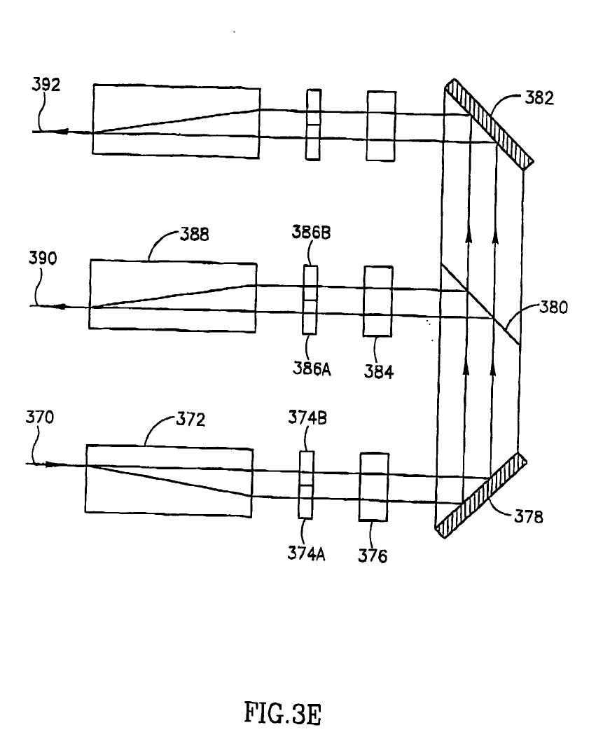

FIG. 3 shows a 1×2 switch 10 according to another exemplary embodiment of the invention. It differs from the 1×2 switch shown in FIG. 2 primarily in that it uses periscopes rather than calcites for the initial separation of the input light into two orthogonally polarized beams, and for recombining the two beams into one beam before the light enters the output channel. This makes the switch in FIG. 3 shorter than the switch in FIG. 2, and/or it makes the separation between the two beams greater in the switch in FIG. 3 than in the switch in FIG. 2. The increased separation between the two beams in the switch in FIG. 3 makes it more practical than in FIG. 2 to send each of the two beams to separate controllable polarization rotators, and for this reason the function of some of the half-wave plates in FIG. 2 can be accomplished by controllable polarization rotators in FIG. 3, and fewer half-wave plates are needed for the switch in FIG. 3. Some disadvantages of the switch in FIG. 3 compared to the switch in FIG. 2 are that the periscopes all require precise alignment of the plates, and precise manufacture of the coatings on the plates, and the periscopes may lose more light than the calcites.

FIG. 3A shows a side view of switch 10, and FIG. 3B shows a top view. Light from an input channel 2 enters a periscope 4, where it is split into two beams. The component of the input light with vertical polarization passes straight through periscope 4, while the component with horizontal polarization is displaced to the right. The vertically polarized beam passes through a controllable polarization rotator 8A, and the horizontally polarized beam passes through a controllable polarization rotator 8B. Controllable polarization rotators 8A and 8B each change vertically polarized light to horizontal polarization, and vice versa, when they are active, and do not change the polarization of light entering them when they are inactive. Optionally, they are made of PLZT. Alternatively, they are made of any of the other materials discussed above in describing controllable polarization rotator 314 in FIG. 2. If controllable polarization rotator 8A is active and controllable polarization rotator 8B is inactive, then the light emerging from both controllable polarization rotators is horizontally polarized. If controllable polarization rotator 8A is inactive and controllable polarization rotator 8B is active, then the light emerging from both controllable polarization rotators is vertically polarized. The light emerging from both controllable polarization rotators enters the lower part of a periscope 12. If the light entering periscope 12 is vertically polarized, then it reflects off both plates 12A and 12B in periscope 12, and emerges from the upper part of periscope 12. If the light entering periscope 12 is horizontally polarized, then it passes through plate 12A and emerges from the lower part of periscope 12. The light emerging from the upper part of periscope 12 ultimately ends up in an output channel 22, while the light emerging from the lower part of periscope 12 ultimately ends up in an output channel 24.

Optionally, to reduce the amount of light going into the wrong channel due, for example, to less than perfect manufacturing of periscope 12 and/or inaccuracy in the operation of controllable polarization rotators 8A or 8B, polarizing plates 18A and 18B are inserted after periscope 12, as described above with respect to polarizers 317A and 317B of FIG. 2. These plates pass only light of the polarization that is supposed to be emerging from the upper and lower parts of periscope 12, and either absorb or scatter light of the wrong polarization. FIG. 3D shows polarizing plates 18A and 18B from an axial point of view.

The two beams emerging from periscope 12 pass through an element 16A, on the left and an element 16A₂ on the right (FIG. 3C), if they emerge from the top of periscope 12. If the two beams emerge from the bottom of periscope 12, then they pass through an element 16B₁ on the left and an element 16B₂ on the right. Optionally, these four elements are mounted on a matrix 16, a shown in FIG. 3C, which is a cross-sectional view of the switch, at the location labeled C-C? in FIG. 3B. Elements 16A₂ and 16B₁ are clear glass or open holes which do not affect the polarization of the light at all, and elements 16A₁ and 16B₂ are half-wave plates which change the polarization of light passing through them from horizontal to vertical, and vice versa. Then, the beam emerging from the left side of matrix 16, whether on the top or the bottom, is horizontally polarized, and light emerging from the right side of matrix 16, whether on the top or the bottom, is vertically polarized. The light emerging from matrix 16 enters a periscope 20. The light entering periscope 20 the left side, because it is horizontally polarized, is reflected from plates 20B and 20A, and emerges from periscope 20 on the right side, while the light entering periscope 20 on the right side, because it is vertically polarized, passes through plate 20A and combines with the light entering periscope 20 on the left side to form a single beam, with the same polarization state (including possibly unpolarized) as the input beam. The emerging single beam goes into output channel 22 if it went through the upper parts of matrix 16 and periscope 20, and it goes into the output channel 24 if it went through the lower parts of matrix 16 and periscope 20. It should be appreciated that if polarization preservation is not required, several elements of the above embodiment may be omitted, for example, beam combiner 20B can be a simple mirror.

Alternatively, in order to reduce the amount of light going into the wrong channel, the elements in matrix 16 are all controllable polarization rotators. If the light is supposed to go into output channel 22, then the elements on the left side of matrix 16 are active and change the polarization direction from horizontal to vertical and vice versa, while elements on the right side of matrix 16 are inactive and do not change the polarization of light passing through them. If the light is supposed to go into channel 24, then the elements on the right side of matrix 16 are active and the elements on the left side of matrix 16 are inactive. Then, light that is headed for the wrong channel will enter periscope 20 with the wrong polarization, and it will not emerge from periscope 20 as a single beam headed for one of the output channels, but will either pass through plate 20B and miss the output channel, or it will reflect from plate 20A and be deflected off to the right, again missing the output channel. Optionally, this light is absorbed in a black material, to minimize stray light entering the output channels.

Optionally, controllable polarization rotators 8A and 8B are operated at intermediate values of electric field, so that the switch operates as a multicaster, as described above for the switch in FIG. 2. Also similarly to the switch in FIG. 2, the switch in FIG. 3 optionally operates as a single output variable attenuator, by blocking one of the outputs. Alternatively it operates as a two-output switch or multicaster with variable attenuation, by using the controllable polarization rotators in matrix 16 to affect the amount of light reaching each output channel, as described for the switch in FIG. 2.

Various other configurations of the switch in FIG. 2 will be obvious to a person skilled in the art, without departing from the teaching of the invention. For example, instead of making the polarization of the two beams the same after the input beam is split into two orthogonally polarized beams, the polarization of the two beams can be kept orthogonal to each other, and the two beams can be made to pass through a single controllable polarization rotator and then through two different periscopes, in order to direct each beam to the proper output channel, before recombining them into one beam. This is more practical if the initial splitting and final recombining of the beam is done with periscopes, rather than with calcites as in FIG. 2, since the beams can be further apart if periscopes are used.

Both the switch shown in FIG. 2 and the switch shown in FIG. 3 can be used as 2×1 switches, with two input channels and one output channel, rather than as 1×2 switches, simply by reversing the input and output channels. Then, by making the controllable polarization rotators (314 in FIG. 2, or 8A and 8B in FIG. 3) either active or inactive, the signal from either input channel can be directed to the output channel. By using intermediate values of electric field in the controllable polarization rotators, any desired combination of the two input signals can be directed to the output channel.

FIG. 3E shows a 1×2 compact switch, which may be useful, for example, to reduce the foot print of a switch, in accordance with an exemplary embodiment of the invention. The input light 370 is conveyed by e.g. collimation means, (as described before) into a YVO₄ crystal 372; the emerging beams (S and P polarizations) pass via half wave plates 374A and B (optionally rotated like 312A and 312B of FIG. 2) and a controllable polarization rotator 376. The latter selects the output port for the beams.

In an exemplary embodiment of the invention, a compact footprint is provided by folding the optical paths. In one example, the beams are reflected by a reflector 378 (e.g., total reflection), and according to their polarization state are either reflected or refracted by a polarizing beam splitter 380. The angle between surface 378 and 380 is, for example, 90 degrees. A surface 382 which is optionally also totally reflecting is used to collect the refracted light If the beams are reflected by splitter 380 they pass through a rotating polarization rotator 384 which together with YVO₄ 388 removes unwanted crosstalk, using a half wave plates 386 as described above. The beams emerge through output channel 390. If the beams are refracted by splitter 380 they are reflected by reflector 382 and exit via an output channel 392 in a similar way to channel 390. It should be noted that this structure may be formed as a stack with the channels one above another, for example, to allow an elongate array of switches to be provided.

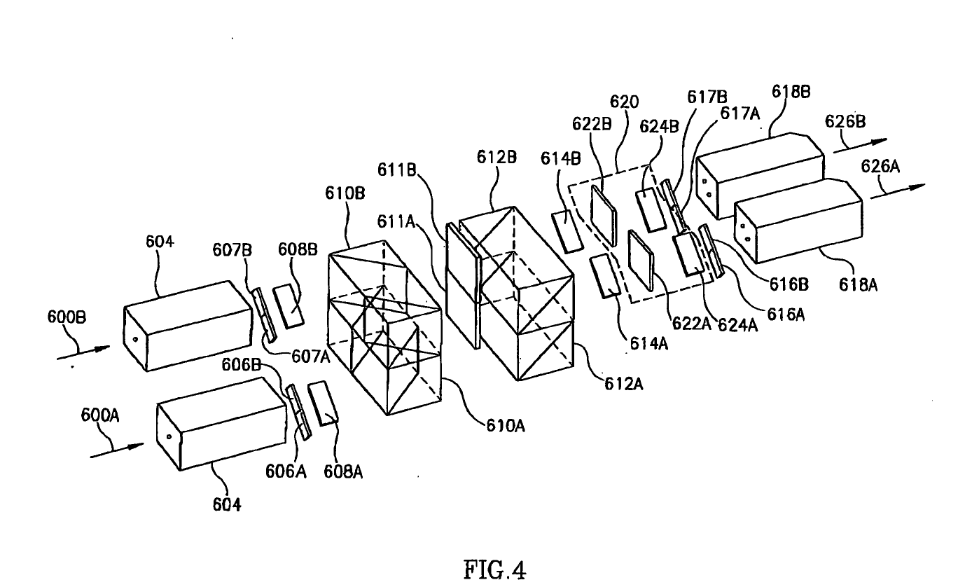

FIG. 4 shows a 2×2 switch, in accordance with an embodiment of the invention. There are two input channels, 600A and 600B, which are directed to two output channels, 626A and 626B. Each input beam passes through a calcite 604, which splits it into two orthogonally polarized beams, polarized at angles of +45 degrees and −45 degrees to the vertical. The four beams each pass through one of the four half-wave plates 606(A,B) and 607(A,B), which rotate their polarization direction by +45 degrees or −45 degrees so that they all emerge polarized in the vertical direction. All four beams then pass through controllable polarization rotators 608(A,B). Optionally there is only one controllable polarization rotator 608, wide enough so that all four beams pass through it. In an exemplary embodiment of the invention, the orientation of polarization rotator(s) 608 is selected to be at 45 degrees to the vertical, so that application of a similarly oriented electric field is facilitated.

If controllable polarization rotators 608 are not active, then the light remains vertically polarized. The light from input channel 600A passes through a plate 610A₁ in a periscope 610A, and is then reflected from plates 612A and 612B in a periscope 612, and eventually reaches output channel 626A. Light from input channel 600B passes straight through a periscope 610B, and then through a half-wave plate 611B, which changes its polarization from vertical to horizontal. It then passes straight through periscope 612B, eventually reaching output channel 626B.

If controllable polarization rotators 608 are active, then the light emerges from them polarized horizontally. Light from input channel 600A is displaced to the left by periscope 610A, and passes through a half-wave plate 611A, which makes its polarization vertical. Periscope 612 then displaces the light upward, and it emerges from periscope 612 aimed at output channel 626B, which it eventually goes into. Similarly, light from input channel 600B eventually ends up at output channel 600A. In summary, light from each input channel goes into the corresponding output channel, 600A into 626A and 600B into 626B, if controllable polarization rotators 608 are inactive, while the light from the two input channels switches places, 600A into 626B and 600B into 626A, if controllable polarization rotators 608 are active.

Optionally there are controllable polarization rotators 614A and 614B together with polarizers 622A and 622B, which serve to reduce cross-talk, keeping light of the wrong polarization (and hence from the wrong input channel) out of each output channel. For example, in one possible configuration of the switch, controllable polarization rotators 614A and 614B are active if and only if controllable polarization rotators 608 are. Then regardless of whether the input channels are switched (600A going into 626B and 600B going into 626A) or not, light from the proper channel will be horizontally polarized in front of polarizer 622B, and vertically polarized in front of polarizer 622A, while light from the wrong channel will have polarization orthogonal to those directions. Polarizer 622A blocks horizontally polarized light and polarizer 622B blocks vertically polarized light, so cross-talk is reduced.

In the configuration just described, the rule for controlling the switch is that all four controllable polarization rotators 608 and 614 are active if the channels are to be switched, and none of the controllable polarization rotators are active is the channels are not to be switched. But other sets of rules will also work, provided that the eight half-wave plates 606, 607, 616, and 617 have corresponding orientations of their principle axes. For example, the rule could be that rotators 608 are active, and rotators 614 are inactive, in order to switch channels. Or, the rule could be that 608A is active, while 608B, 614A, and 614B are inactive, in order to switch channels.

Optionally, there are controllable polarization rotators 624A and 624B, which, together with calcites 618A and 618B, serve as variable attenuators for each output channel. By changing the polarization state away from the polarization, pure horizontal or pure vertical, which is designed to go through each output channel, controllable polarization rotators 624A and 624B can reduce the amount of light that enters each channel. If light of the wrong polarization enters calcite 618A or 618B, the beams will not recombine and enter the output channels 626A or 626B, but will be displaced to the side.

By operating controllable polarization rotators 608 at intermediate values of electric field, the switch can act like a variable adder, putting any desired linear combination of the two input channels into one output channel, and the remaining power from each input channel into the other output channel.

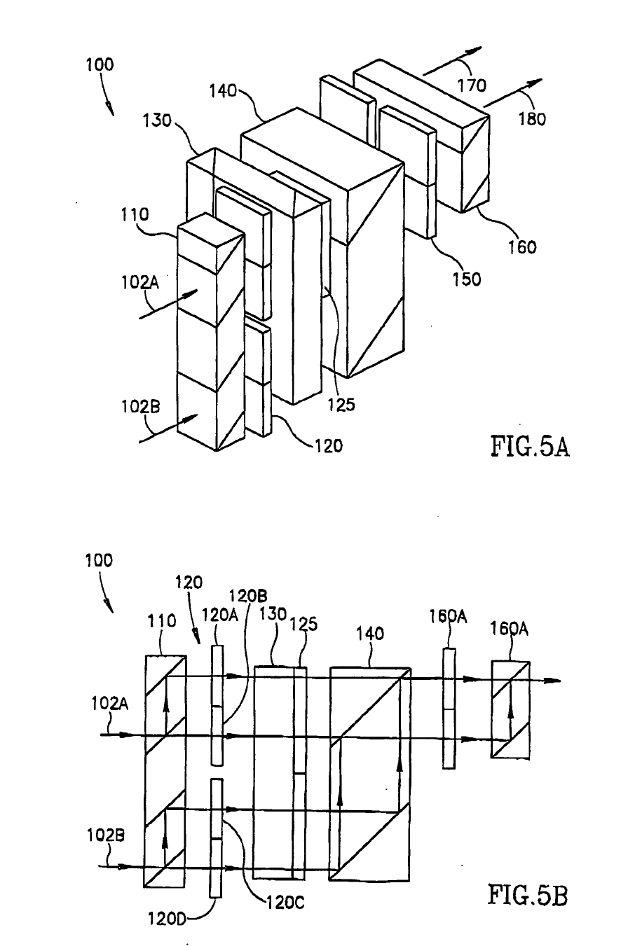

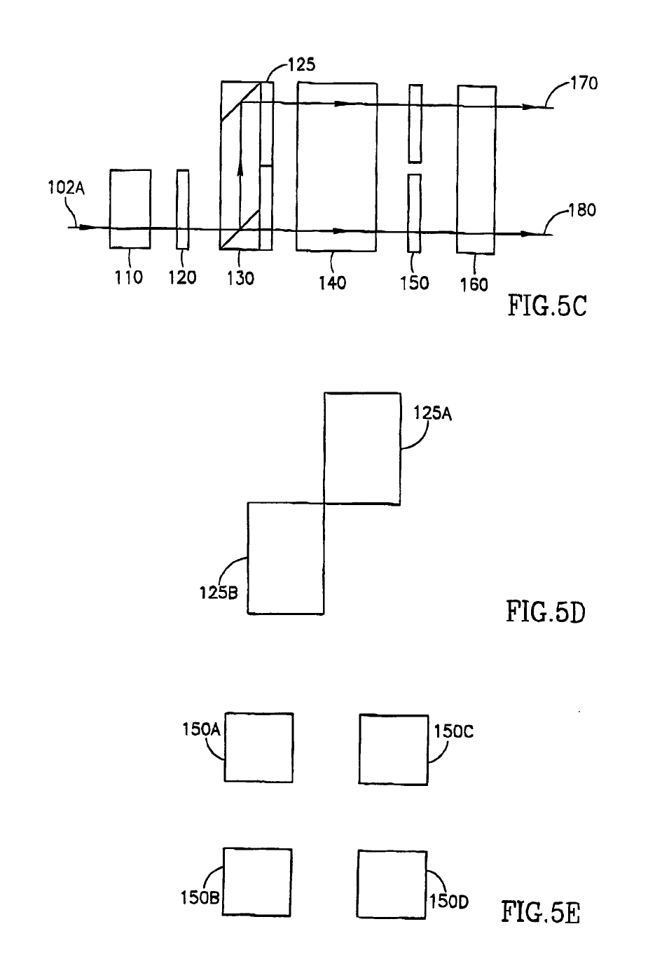

Optionally, input channel 600B, and the associated calcite 604B, half-wave plates 607 and controllable polarization rotator 608B, are directly above input channel 600A, instead of being above and to the left of it. Then periscope 610B is changed so that it displaces a beam to the left instead of to the right, and the rule for when the controllable polarization controllers are active is changed, or else the directions of orientation of the principle axes of the half-wave plates 607 are changed. The resulting configuration resembles FIG. 5.

FIG. 5 shows a 2×2 switch 100 according to another exemplary embodiment of the invention. Like the 1×2 switch shown in FIG. 3, the 2×2 switch shown in FIG. 5 differs from the 2×2 switch shown in FIG. 4 primarily in using periscopes instead of calcites for the initial splitting of the beam into two beams of orthogonal polarizations, and for the final recombining of the two beams into a single beam. The advantages and disadvantages of the configuration shown in FIG. 5 are similar to those described for FIG. 3. Optionally, an optical blocker or absorber is provided between stacked periscopes, for example to reduce cross-talk. FIG. 5A shows a three-dimensional perspective view of switch 100, FIG. 5B shows a side view, and FIG. 5C shows a top view. Light from input channels 102A and 102B passes through a periscope 110, which is really two periscopes one stacked on top of the other, and the light from each channel is divided into two beams, polarized vertically and horizontally. Controllable polarization rotators 120 make the polarization of both beams from a given input the same, and make the polarization vertical for the beams which are going to end up at an output channel 170, and horizontal for the beams which are going to end up at an output channel 180. A periscope 130 then displaces the beams to the left if they are supposed to go to output channel 180, and keeps them on the right if they are supposed to go to output channel 180. Half-wave plates 125A and 125B, shown in FIG. 5D which is a cross-sectional view (and indicated as 125 in FIGS. 5A and 5B), change the polarization of some of the beams, so that all beams end up at the upper part of a periscope 140, regardless of which output channel they are going to. Finally, controllable polarization rotators 150, shown in a cross-sectional view in FIG. 5E, restore the beams whose polarization was changed to the polarization they had when they emerged from periscope 110. A periscope 160 recombines each pair of beams from the same input channel into one combined beam again, which goes out output channel 170 or 180, depending on whether that combined beam is on the left side or the right side of the switch.

Variable attenuation and mixing can be achieved in switch 100 by using intermediate values of electric field in controllable polarization rotators 150 and 120 respectively, similar to the switch in FIG. 4.

FIG. 6 is a 2×2 switch according to another exemplary embodiment of the invention. This switch uses calcites not only for separating beams initially into orthogonal polarized components, like the switches in FIG. 2 and FIG. 4, but even uses calcites for displacing beams according to which output channel they are going into, a function performed by a periscope in other embodiments. While this makes the switch in FIG. 6 longer than the other switches, there are no periscopes to manufacture, and the calcites can be used over a much broader range of wavelengths than a typical periscope can, with its precise optical coatings and angles. Furthermore, the layout of the switch shown in FIG. 6, unlike those in FIG. 4 and FIG. 5, is largely confined to the plane of the drawing, and can have rather small width in the direction perpendicular to the plane of the drawing. This allows many such switches to be stacked up in parallel in a relatively small space.

Light beams from two input channels 802A and 802B each enter a calcite 800A or 800B, where they are separated into beams polarized vertically and horizontally. Each of the resulting four beams passes through a different half-wave plate 804, which are oriented in such a way that all four beams emerge with the same polarization direction, 45 degrees from the vertical. (The half-wave plates are oriented with their principle axes either 22.5 degrees or 67.5 degrees from the vertical.) The beams then pass through a controllable polarization rotator 806, which has its electric field oriented horizontally, perpendicular to the plane of the drawing. The horizontal orientation of the electric field allows controllable polarization rotator 806 to be made very narrow in the direction of the electric field, with broad flat electrodes mounted on each side of it, producing a uniform field, and not requiring a very high voltage to obtain a high electric field.

Light passing through controllable polarization rotator 806 has its polarization changed by 90 degrees, from +45 degrees to −45 degrees or vice versa, when controllable polarization rotator is active, with an electric field of the right magnitude. When it is inactive, with no electric field, the polarization of light passing through it remains the same. The light then passes through a half-wave plate 807, with principle axes oriented in such a way (either 22.5 or 67.5 degrees from the vertical) so that the light emerging from controllable polarization controller 806 is all rotated by 90 degrees, and hence has either horizontal or vertical polarization. The four beams then enter a calcite 808, where the beams that are vertically polarized are deflected downward, while the beams that are horizontally polarized pass straight through. Light entering calcite 808 which came from input channel 802B goes to location 808C if it is not deflected, and goes to location 808B if it is deflected. Light entering calcite 808 which came from input channel 802A goes to location 808B if it is not deflected, and goes to location 808A if it is deflected. There is a half-wave plate 809 at location 808B, which rotates the polarization of light passing through it by 90 degrees, changing horizontal to vertical polarization and vice versa. The light then passes through a calcite 810, where it goes straight through if it is polarized horizontally, and is deflected upward if it is polarized vertically.

In order to send the signal from each input channel to the corresponding output channel, i.e. to send input channel 802A to an output channel 820A, and to send input channel 802B to an output channel 820B, the light from input channel 802B arrives at calcite 808 with horizontal polarization, and the light from input channel 802A arrives at calcite 808 with vertical polarization. Then the light from input channel 802B goes to location 808C and from there, through calcite 810, to output channel 820B. Light from input channel 802A is deflected down to location 808A, and then deflected back up through calcite 810 to output channel 820A. All four light beams miss half-wave plate 809, so they have the same polarization in calcite 810 as they have in calcite 808.

In order to switch channels, i.e. to send the signal from input channel 802A to output channel 820B, and the signal from input channel 802B to output channel 802A, the light from input channel 802B arrives at calcite 808 with vertical polarization, and the light from input channel 802A arrives at calcite 808 with horizontal polarization. Then all four beams go to location 808B, the beams from channel 802A because they are not deflected, and the beams from channel 802B because they are deflected. All four beams pass through half-wave plate 809 and have their polarization direction changed by 90 degrees. Then the light that came from input channel 802A has vertical polarization and is deflected upward through calcite 810, reaching output channel 820B, while the light that came from input channel 802B has horizontal polarization, and is not deflected in calcite 810, so goes straight through calcite 810 and reaches output channel 820A.

It should be noted that the eight lines shown in calcite 808 and calcite 810 in FIG. 6 do not represent eight different beams that are present at the same time. Rather, at any given time, there are only four beams present, but the eight beams shown in FIG. 6 represent both possible locations of each of the four beams, depending on whether the channels are switched or not switched.

Once they emerge from calcite 810, all four beams pass through a half-wave plate 812, oriented with its principle axis either 22.5 degrees or 67.5 degrees from the vertical. This half-wave plate rotates the polarization of the light by 45 degrees, so the polarization of each beam is oriented either 45 degrees to the left of vertical or 45 degrees to the right of vertical, whatever it was before passing through half-wave plate 807 if the channels were not switched, or 90 degrees different from that if the channels were switched. In either case, the polarization is the same as it is for light in the corresponding location (top or bottom) before passing through half-wave plate 807. The light then passes through a controllable polarization rotator 814, which is either active or not depending on whether controllable polarization rotator 806 is active, and emerges with the same polarization as the corresponding location (top or bottom) of light before it has entered controllable polarization rotator 806. Finally, the four beams each pass through a different one of four half-wave plates 816, oriented the same way as corresponding half-wave plates 804, and enter calcites 818A and 818B. Because the two beams that enter each of calcite 818A and 818B have the same polarization as the corresponding beams leaving calcites 800A and 800B, they recombine to form a single beam in each calcite, which emerges from that calcite and enters the corresponding output channel 820A or 820B.

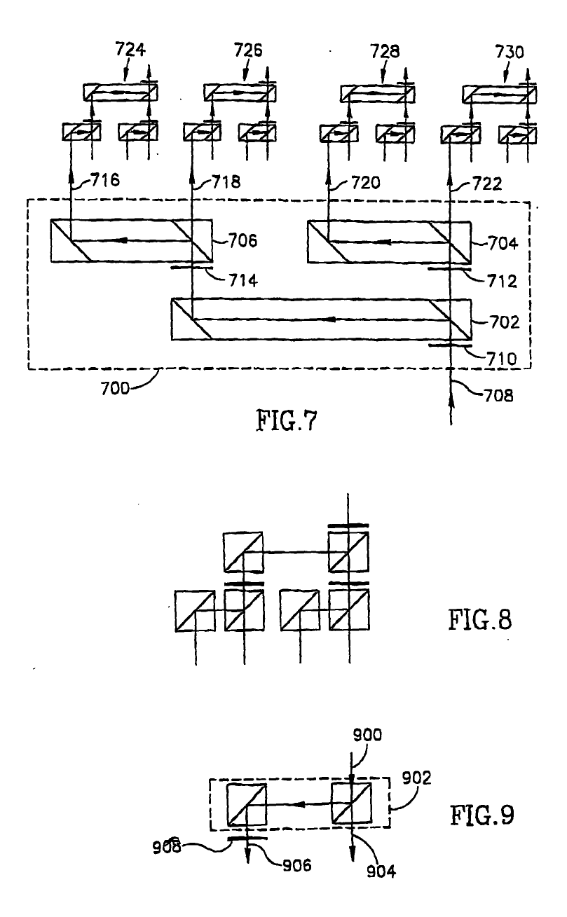

FIG. 7 shows the topology of a router-selector network with four input channels, each of which goes to a different one of four output channels. There are four router sections, each one for a different input channel, but for simplicity, only one such router section 700 is shown in FIG. 7. Each router section consists of three polarizing beam splitters 702, 704, and 706, which can be periscopes or calcites. In FIG. 7, the polarizing beam splitters are shown as periscopes. There is a controllable polarization rotator in front of each periscope. Light from the input channel, assumed to already be polarized (for example using the techniques described above), enters router section 700 at point 708, and passes through controllable polarization rotator 710 before entering periscope 702. Depending on whether controllable polarization rotator 710 is active or inactive, the light entering periscope 702 is directed either to periscope 704 or periscope 706. Controllable polarization rotators 712 and 714 in front of periscopes 704 and 706 direct the light to one of four outputs 716, 718, 720 and 722, depending on whether controllable polarization rotators 712 and 714 are active or inactive.

Controllable polarization rotators 712 and 714 need not be controlled independently. Optionally, both of these controllable polarization rotators are controlled by a single input voltage. If there were eight output channels or 16 output channels, there would be one or two additional stages of periscopes and controllable polarization rotators in the router. In each stage, all of the controllable polarization rotators are optionally controlled by a single input voltage. The list of input voltages (zero or full voltage) to the controllable polarization rotators in each stage gives the binary code for the desired output. Optionally, if it is expected that the network will frequently switch between adjacent output channels, and it is desired to minimize the amount of changing of input voltages to the controllable polarization rotators, then the list of input voltages gives the Grey code for the desired output instead of the binary code. This is accomplished by wiring some of the controllable polarization rotators so that fill input voltage makes the controllable polarization rotator inactive and zero input voltage makes it active.

For each output channel there is a selector section, in which all the inputs going to that output are merged together. In FIG. 7, selector section 724 corresponds to output 716 of router section 700, selector section 726 corresponds to output 718, selector section 728 corresponds to output 720, and selector section 730 corresponds to output 722. Each selector section consists of a branching tree of periscopes, exactly like each of the router sections but in reverse order. The periscopes in the selector sections also optionally have controllable polarization rotators associated with them, in order to block unwanted paths and decrease cross-talk.

Although the selector sections are shown schematically in the same plane as the router section in FIG. 7, in fact it is convenient to stack the router sections, one for each input, above each other in a direction perpendicular to the plane of the drawing. The selector sections are then each laid out in a plane perpendicular to the plane of each router section.

FIG. 8 shows the geometry of periscopes and controllable polarization rotators for either a router section or a selector section. The periscopes are each made up of two cells, not necessarily adjacent to each other, with an optically coated plate mounted diagonally in each cell, and in each periscope one of the cells has a controllable polarization rotator mounted outside it.

The router and selector sections as described up to now are assumed to have polarized input and output. If the real input and output channels use unpolarized light, or light of arbitrary polarization, then it may be desirable to first split the input light into two orthogonally polarized beams, using the entrance stage shown in FIG. 9. An input beam 900 goes into a periscope 902, and is split into two polarized beams 904 and 906. Optionally, a half-wave plate 908 rotates the polarization of one of the beams by 90 degrees, so that the two beams have the same polarization. Each of these beams is then fed into its own router-selector network. Alternatively, the two beams keep their different polarizations when each one enters its own router-selector network, and the layouts of the two networks take this into account. At the end, the two output beams for each output channel are merged together again, using an exit stage resembling the entrance stage in FIG. 9.

The invention has been described in the context of the best mode for carrying it out. It should be understood that not all features shown in the drawings or described in the associated text may be present in an actual device, in accordance with some embodiments of the invention. Furthermore, variations on the method and apparatus shown are included within the scope of the invention, which is limited only by the claims. Also, features of one embodiment may be provided in conjunction with features of a different embodiment of the invention. As used herein, the terms “have”, “include” and “comprise” or their conjugates mean “including but not limited to.” The term “calcite” is used herein to mean any birefringent crystal which is used as a polarizing beam splitter, including synthetic materials such as yttrium vanadate.

1. A polarizing beam-splitter apparatus, comprising:
an input port through which an input beam of light is provided;
a first polarizing beam splitter that receives the input beam and splits the beam into at least a first and second beam, said first beam having substantially a first desired polarization state and said second beam having a second polarization state orthogonal to said first polarization state but possibly admixed with the first polarization state; and
an optical system that receives the second beam and provides a third beam having the second polarization state and a smaller admixture of the second polarization state than the second beam.

2. A polarizing beam-splitter apparatus according to claim 1 wherein the first beam splitter comprises a first planar surface that reflects light having the second polarization state and transmits light having the first polarization state and wherein the input beam is incident on the surface at a first angle.

3. A polarizing beam-splitter apparatus according to claim 2 wherein the first angle is substantially 45°.

4. A polarizing beam-splitter apparatus according to any of the preceding claims, wherein the optical system comprises a polarizing beam splitter that receives the second beam and splits the second beam into the third beam and a fourth beam having substantially the first polarization state.

5. A polarizing beam-splitter apparatus according to any of claims 1-4 wherein the optical system comprises a second beam splitter having a second planar surface that reflects light having the second polarization state and transmits light having the first polarization state and wherein the second beam is incident on the second planar surface at a second angle and light reflected by the second surface from the second beam forms the third beam and light transmitted by the second surface forms a fourth beam.

6. A polarizing beam-splitter apparatus according to claim 5 and comprising an absorber that receives the fourth beam.

7. A polarizing beam-splitter apparatus according to any of claims 5-6 wherein the second angle is substantially 45°.

8. A polarizing beam-splitter apparatus according to any of claims 5-7 wherein the first and second surfaces are substantially parallel as a result of which, the first and third beams are parallel and displaced from each other.

9. A polarizing beam-splitter apparatus according to any of claims 5-7 wherein the first and second surfaces are surfaces formed on a same substrate material substantially transparent to light in the input beam.

10. A polarizing beam-splitter apparatus according to any of claims 1-9 and comprising:
at least one controllable polarization rotator positioned to receive one of the first and third beams and operable to change the polarization state of the beam it receives; and
a polarizer that receives the beam from the rotator and transmits an amount of optical energy in the received beam responsive to the polarization state of the beam.

11. A polarizing beam-splitter apparatus according to claim 10 wherein the at least one controllable polarization rotator comprises a polarization rotator for each of the first and second beams.

12. A polarizing beam-splitter apparatus according to claim 10 or claim 11 wherein the polarization rotator comprises:
at least one volume of PLZT through which light received by the rotator is transmitted; and
at least one electrode for applying a voltage to the volume of PLZT, which voltage controls the state to which the rotator changes the polarization of light that the rotator receives.

13. Apparatus according to any of claims 10-12, comprising a pair of polarization rotators arranged around said polarization controller, to rotate polarization of light entering and exiting said controller.

14. Apparatus according to claim 13, wherein an electric field direction of said controller is perpendicular to a plane common to said beams.

15. An optical switch comprising an input port through which the switch receives light and first and second output ports to which the switch selectively directs light that it receives comprising:
a first polarization state apparatus that receives light from the input port and provides a light beam having a desired polarization state;
a polarizing beam-splitter apparatus according to any of claims 1-9 that receives the light beam from the polarization state apparatus at the beam splitter apparatus input port and generates at least one first beam and/or at least one third beam responsive to the polarization of the light that it receives; and
wherein the first output port receives light from the at least one first beam and the second output port receives light from the at least one third beam.

16. An optical switch according to claim 15 and comprising:
a polarizing beam splitter that receives light from the input port and generates fifth and sixth spatially separated beams therefrom said fifth beam having substantially a third polarization state and said sixth beam having a fourth polarization state substantially orthogonal to the third state;
a second polarization state apparatus that receives the first and second beams of light and changes the polarization state of at least one of the fifth and sixth beams so that the polarization state of both beams is the same; and
wherein the fifth and sixth beams are directed to the input port of the beam splitter apparatus, which apparatus generates a first and/or third beam responsive to the fifth beam and a first and/or third beam responsive to the sixth beam.

17. An optical switch according to claim 16 comprising a first polarizer through which light from the first beams from the polarizing beam-splitter apparatus is transmitted and wherein said first polarizer transmits substantially only light having the first polarization state.

18. An optical switch according to claim 16 or claim 17 comprising a second polarizer through which light from the third beams from the polarizing beam-splitter apparatus is transmitted and wherein said second polarizer transmits substantially only light having the second polarization state.

19. An optical switch according to claim any of claims 16-18 comprising:
an first optical combiner that combines light in the first beams provided by the beam splitter apparatus responsive to light in the fifth and sixth beams and directs the combined light to the first output port.

20. An optical switch according to claim 19 comprising:
a second optical combiner that combines light in the third beams provided by the beam splitter apparatus responsive to light in the fifth and sixth beams and directs the combined light to the second output port.

21. An optical switch according to claim 19 wherein the first optical combiner comprises:
a third polarization state apparatus that receives the first beam provided from light in the fifth beam and transmits the light in the third polarization state and receives the light in the first beam provided by light from the sixth beam and transmits the light in the fourth polarization state;
an optical joiner that receives light in first beams from the third polarization state apparatus and combines the received light into a single beam that is transmitted to the first output port.

22. An optical switch according to claim 20 wherein the second optical combiner comprises:
a fourth polarization state apparatus that receives the third beam provided from light in the fifth beam and transmits the light in the third polarization state and receives the light in the third beam provided by light from the sixth beam and transmits the light in the fourth polarization state;
an optical joiner that receives light in the third beams from the fourth polarization state apparatus and combines the received light into a single beam that is transmitted to the second output port.

23. An optical switch according to claim 19 or claim 21 and comprising a first controllable attenuator controllable to attenuate light from the first combiner by a desired attenuation before the light reaches the first output port.

24. An optical switch according to claim 20 or claim 22 and comprising a second controllable attenuator controllable to attenuate light from the second combiner by a desired attenuation before the light reaches the second output port.

25. An optical switch according to claim 22 wherein the first attenuator comprises:
at least one controllable polarization rotator positioned to receive the light from the first combiner and operable to change the polarization state of the light it receives; and
a polarizer that receives the beam from the rotator and transmits an amount of optical energy in the received responsive to the polarization state of the light.

26. An optical switch according to claim 23 wherein the second attenuator comprises:
at least one controllable polarization rotator positioned to receive the light from the second combiner and operable to change the polarization state of the light it receives; and
a polarizer that receives the beam from the rotator and transits an amount of optical energy in the received responsive to the polarization state of the light.

27. An optical switch according to claim according to claim 25 or claim 26 wherein the polarization rotator comprises:
at least one volume of PLZT through which light received by the rotator is transmitted; and
at least one electrode for applying a voltage to the volume of PLZT, which voltage controls the state to which the rotator changes the polarization of light that the rotator receives.

28. A switch array comprising a plurality of switches according to any of claims 15-27, sharing an elongated optical element, said elongation being perpendicular to a plane of each of said switches.

29. A switch according to any of claims 15-27, comprising at least one reflector for folding an optical path of said switch.

30. A compound optical switch comprising at least two optical switches according to any of claims 14-26 wherein the first output port of each optical switch is a same single first shared output port and the second output port of each optical switch is a same single second shared output port.

31. A compound optical switch comprising a cascade of optical switches wherein an n-th tier of the cascade comprises 2ⁿ optical switches according to any of claims 15-27 and wherein light from the first and second output ports of an optical switch in the n-th tier is input to the input ports of two optical switches in the (n+1)-st tier.

32. A compound optical switch according to claim 31 wherein each optical switch in the n-th tier receives light from only a single output port of the optical switches in the (n−1)st tier.

33. A compound optical switch according to claim 31 or claim 32 comprising N tiers and comprising an output port that receives light from at least two output ports of the optical switches in the n-th tier.

34. A router-selector optical switching network, comprising:
a number of input channels equal to a power of two;
a number of output channels equal to the same or a different power of two;
a router section for each input channel comprising a binary branching tree of polarizing beam splitters, light paths joining them, and controllable polarization rotators;
a selector section for each output channel comprising a binary branching tree of polarizing beam joiners, light paths joining them, and controllable polarization rotators;
wherein the controllable polarization rotators operate to control the connection of any output channel to at most one input channel and any input channel to at most one output channel.

35. A router-selector optical switching network according to claim 34, wherein the light paths of each router are co-planar, the light paths of each selector are co-planar, the planes of all the router light paths are parallel to each other, the planes of all the selector light paths are parallel to each other, and the planes of all the router light paths are perpendicular to the planes of all the selector light paths.

36. A router-selector optical switching network according to claim 34 or claim 35, wherein at least one of the polarizing beam splitters or one of the polarizing beam joiners is a polarizing beam splitter apparatus according to any of claims 1-14.

37. A method of aligning a first optical element with a second optical element comprising:
mounting the first optical element on a first part of a support comprising first and second parts, wherein the first part is movably coupled to the second part;
mounting the second part of the support in a fixed position relative to the second optical element;
applying a curable adhesive to the support so that the adhesive contacts both the first and second parts;
moving the first part so that the first optical element is aligned with the second optical element, and
curing the adhesive to secure the first part in the aligned position.

38. An optical configuration, comprising:
a substrate;
at least two optical elements that lie in a same path and are coupled to said substrate; and
at least one ball and socket joint formed between at least one of said elements and said substrate, such that said one element can be oriented on said joint in a plurality of orientations relative to the other one of said elements.

39. An optical configuration according to claim 38, and including curable adhesive in the bearing.

40. An optical configuration according to claim 39, wherein the curable adhesive is cured by ultraviolet light.

41. An optical configuration according to any of claims 38-40, wherein said adhesive is viscous and prevent slipping of said joint when no external forces are applied to said optical element.

42. An optical configuration according to any of claims 38-41, wherein said one optical element or said substrate is transparent to ultraviolet light.

43. An optical configuration according to any of claims 38-42, wherein said ball is on said substrate.

44. An optical configuration according to any of claims 38-42, wherein said ball is on said element.

45. An optical configuration according to any of claims 38-44, wherein said ball is integral to one of said substrate and said element.

46. An optical configuration according to any of claims 38-44, wherein said ball is mounted on one of said substrate and said element.

47. An optical configuration according to claim 46, wherein said ball is attached using an adhesive to said one of said substrate and said element.
